(19) United States
(12) Patent Application Publication
(10) Pub. No.: US 2026/0278247 A1
(43) Pub. Date: Sep. 17, 2026

(54) AUTOMATED ASSESSMENT OF NOTE QUALITY USING CLUSTERING

(71) Applicant: SAP SE, Walldorf (DE)

(72) Inventors: Nibedita Dutta, Gurgaon (IN); Sudhir Verma, Gurgaon (IN); Neha Garg, bangalore (IN); Ayush Agrawal, Rajasthan (IN)

(21) Appl. No.: 19/077,449

(22) Filed: Mar. 12, 2025

(51) Int. Cl. G06F 40/166; G06F 16/28

(52) U.S. Cl. CPC G06F 40/166; G06F 16/285

(57) ABSTRACT

Example methods and systems are directed to automated assessment of note quality using clustering. Features for each note may be automatically determined. A clustering algorithm is applied to cluster the notes based on their features. The clusters may be labeled as good, bad, or poor. An isolation forest algorithm may also be applied to the notes to detect anomalous notes that are substantially lower in quality than average notes. The set of anomalous notes is compared with the cluster of poor quality notes to identify a set of filtered poor quality notes to be brought to the attention of a user for improvement. Specific suggestions for the improvement of notes may be generated by evaluating sentences in historical support tickets.

### TECHNICAL FIELD

The subject matter disclosed herein generally relates to automated assessment of notes that include information for solving problems. Specifically, the present disclosure addresses systems and methods to automatically assess notes using clustering.

### BACKGROUND

Knowledge bases include many notes with information that users may find helpful in solving problems. Notes with good quality and content can expedite the successful resolution of problems. However, notes may be outdated or poorly written. Due to the large number of notes in a knowledge base, manual assessment of the quality of each note is infeasible.

### BRIEF DESCRIPTION OF THE DRAWINGS

Some embodiments are illustrated by way of example and not limitation in the figures of the accompanying drawings.

FIG. 1 is a network diagram illustrating a network environment suitable for automated assessment of note quality using clustering, according to some example embodiments.

FIG. 2 is a block diagram of an assessment server, according to some example embodiments, suitable for automatically assessing note quality using clustering, according to some example embodiments.

FIG. 3 is a block diagram of a database schema, according to some example embodiments, suitable for use in storing and categorizing notes.

FIG. 4 is a block diagram of a model architecture for automated assessment of note quality using clustering, according to some example embodiments.

FIG. 5 is a flowchart illustrating operations of a method suitable for automated assessment of note quality using clustering, according to some example embodiments.

FIG. 6 is a block diagram showing one example of a software architecture for a computing device.

FIG. 7 is a block diagram of a machine in the example form of a computer system within which instructions may be executed for causing the machine to perform any one or more of the methodologies discussed herein.

### DETAILED DESCRIPTION

Example methods and systems are directed to automated assessment of note quality using clustering. As used herein, the word note refers to a collection of text, regardless of format. Example notes include knowledge base entries, word processing files, emails, academic papers, court cases, books, scripts, text submitted through web-based forms, and so on.

Prior to the automated assessment of the notes, the notes may be categorized according to a product, component, or area to which they apply. The term “component” will be used an as umbrella term to cover all of these options. The assessment of note quality may be performed on a per-component basis. The categorization of notes may be performed manually. For example, when a note is created, it may be assigned by the creator to a component. Alternatively, the categorization of notes may be performed automatically, using a machine-learning model.

Features for each note may be automatically determined. For example, text of a note may be evaluated to determine a number of technical terms, a total number of terms, a number of unique keywords, or any suitable combination thereof. Other features for each note may also be gathered. For example, a number of historical incidents that were solved by the note may be counted.

A clustering algorithm is applied to cluster the notes based on their features. The clusters may be labeled as good, bad, or poor. An isolation forest algorithm may also be applied to the notes to detect anomalous notes that are substantially lower in quality than average notes. The set of anomalous notes is compared with the cluster of poor quality notes to identify a set of filtered poor quality notes to be brought to the attention of a user for improvement.

Specific suggestions for the improvement of notes may be generated by evaluating sentences in historical support tickets (e.g., in the title or description of historical support tickets). Using cat swarm optimization, cosine similarity, or both, sentences are identified that would improve the relevancy of a note to the problems to which the note is applied. The sentences are suggested to the user for inclusion in the note.

By comparison with existing methods of detecting and modifying poor quality notes, the methods and systems discussed herein reduce the level of effort expended in both the detection and modification steps, thereby improving the quality of knowledge bases.

When these effects are considered in aggregate, one or more of the methodologies described herein may obviate a need for certain efforts or resources that otherwise would be involved in assessing and improving note quality. Computing resources used by one or more machines, databases, or networks may similarly be reduced. Examples of such computing resources include processor cycles, network traffic, memory usage, data storage capacity, power consumption, and cooling capacity.

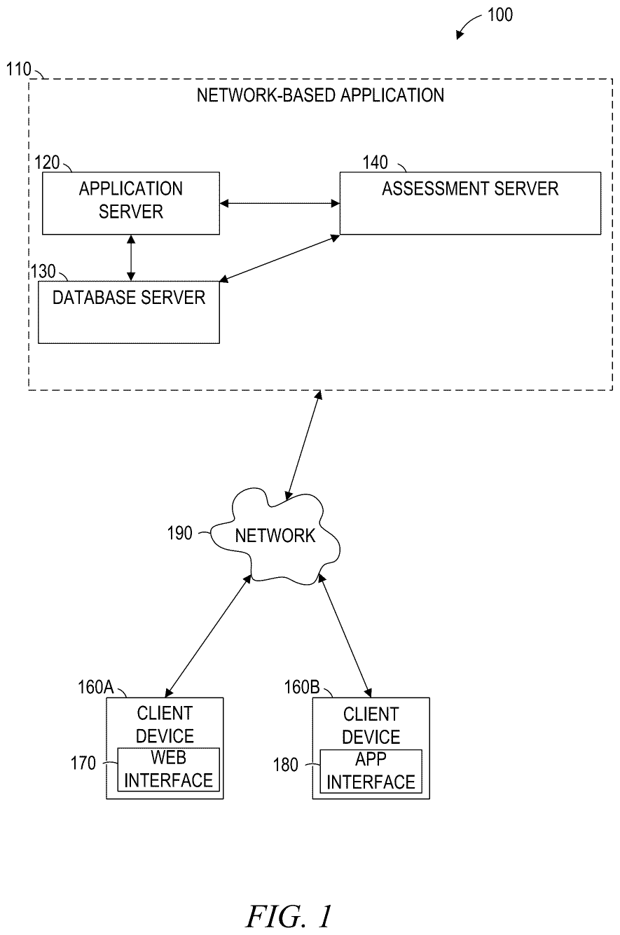

FIG. 1 is a network diagram illustrating a network environment 100 suitable for automated assessment of note quality using clustering, according to some example embodiments. The network environment 100 includes a network-based application 110, client devices 160A and 160B, and a network 190. The network-based application 110 is provided by application server 120 in communication with a database server 130, and an assessment server 140. The application server 120 accesses application data (e.g., application data stored by the database server 130) to provide one or more applications to the client devices 160A and 160B via a web interface 170 or an application interface 180. For example, the application server 120 may provide a support application that receives help requests from the client devices 160, accesses a knowledge base to identify responsive notes, and sends a response to each help request to the requesting client device 160.

The application server 120, the database server 130, the assessment server 140, and the client devices 160A and 160B may each be implemented in a computer system, in whole or in part, as described below with respect to FIG. 11. The client devices 160A and 160B may be referred to collectively as client devices 160 or generically as a client device 160.

The assessment server 140 accesses data for support requests and notes from the database server 130. Using the accessed data, the assessment server 140 automatically assesses the quality of the notes. A user interface may be presented that identifies low-quality notes along with suggestions for improving them.

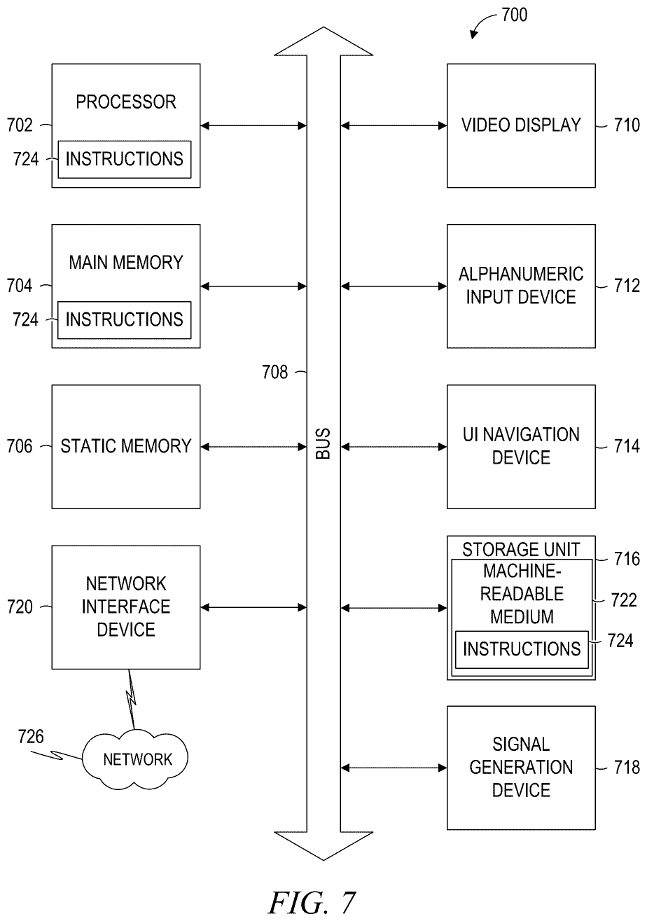

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the assessment server 140, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

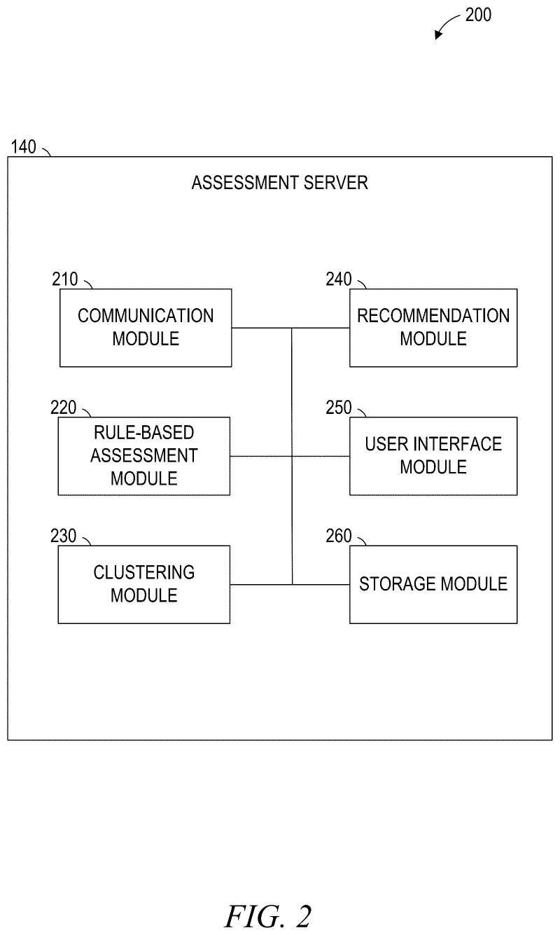

FIG. 2 is a block diagram 200 of the assessment server 140, according to some example embodiments, suitable for automatically assessing note quality using clustering, according to some example embodiments. The assessment server 140 is shown as including a communication module 210, a rule-based assessment module 220, a clustering module 230, a recommendation module 240, a user interface module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the assessment server 140 and transmits data from the assessment server 140. For example, the communication module 210 may receive, from the application server 120 or the database server 130, notes to be automatically assessed. Assessment results and recommendations may be provided to the application server 120 or a client device 160 by the communication module 210. The results may also be stored in the database of the database server 130 via the storage module 260. Communications sent and received by the communication module 210 may be intermediated by the network 190.

The rule-based assessment module 220 applies rules to assess the notes. For example, a numerical rating may be assigned to each note based on a number of support tickets resolved by the note, a number of keywords contained in the note, an age of the note, or any suitable combination thereof. Based on the numerical rating and a predetermined threshold, each note may be assigned to an assessment category. For example, the rule-based assessment module 220 may divide the notes into two categories, excellent notes and other notes.

The clustering module 230 uses clustering to assess the notes. The notes assessed by the clustering module 230 may be all of the notes accessed from the database server 130 or a subset thereof. For example, the clustering module 230 may assess only the notes identified by the rules-based assessment module 220 as not being excellent. A vector representation of each note being clustered may be created based on text of the note, a number of support tickets resolved by the note, a number of keywords contained in the note, an age of the note, or any suitable combination thereof. The vector representations may be clustered using k-means clustering into a predetermined number of clusters. Each cluster may be represented by its centroid and, based thereon, ranked as high-, medium-, and low-quality.

Low-quality notes may be improved by adding information to them. To aid in this process, the recommendation module 240 generates, for one or more low-quality notes, a recommendation for improvement. The recommendation may be formed by analyzing support tickets associated with the note to identify relevant sentences that may be added to the note.

The recommendation may be presented in a user interface generated by the user interface module 250. For example, the user interface module 250 may generate hypertext markup language (HTML) that is sent to a client device 160 for rendering by a web browser. A user may accept the recommendation or modify the recommended text. The user-approved text is submitted via the user interface and the note is updated in the knowledge base, thereby improving the quality of the knowledge base.

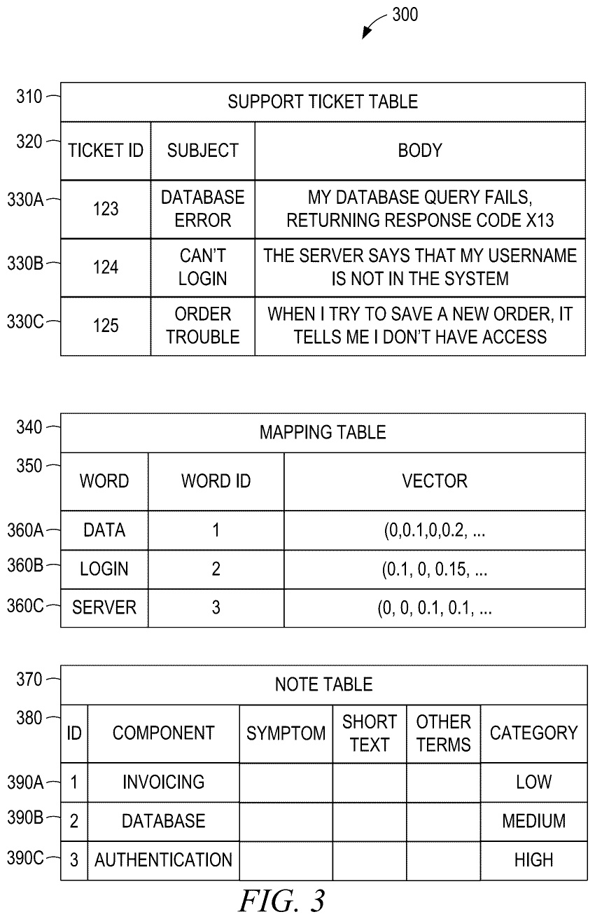

FIG. 3 is a block diagram of a database schema 300, according to some example embodiments, suitable for use in storing and categorizing notes. The database schema 300 includes a support ticket table 310, a mapping table 340, and a note table 370. The support ticket table 310 includes rows 330A, 330B, and 330C of a format 320. The mapping table 340 includes rows 360A, 360B, and 360C of a format 350. The note table 370 includes rows 390A, 390B, and 390C of a format 380.

The format 320 of the support ticket table 310 includes a ticket identifier field, a subject field, and a body field. Each of the rows 330A-330D stores data for a single support ticket. The ticket identifier is a unique identifier for the support ticket. For example, when a support ticket is received, the application server 120 may assign the next unused identifier to the received support ticket. The subject and the body of the support ticket are two text fields with different, but related, text. For example, the subject of the request 123 (in the row 430A) is “Database Error” while the body of the request, “My database query fails, returning response code X13” contains more detailed information about the database error.

The format 350 of the mapping table 340 includes a word, a scalar word identifier for the word, and a vector that is mapped to the word. In some example embodiments, the word vector is in a high-dimensional space (e.g., includes one hundred or more dimensions). Accordingly, only a portion of each vector is shown in FIG. 3.

Each of the rows 390A-390C of the note table 370 includes a note identifier; a software component to which the note applies; text fields that comprise the note itself, such as a symptom, short text, and other terms; and an assessment category assigned to the note, as indicated by the format 380. In various example embodiments, more or fewer elements may be included in the note table 370 or otherwise referenced in the database schema 300. For example, the note table 370 may also contain, for each note, identifiers of tickets of the support ticket table 310. The identified tickets may be tickets that were solved using the note. Data for each note may also include a reason, pre-requisites, a solution, a cause, or any suitable combination thereof.

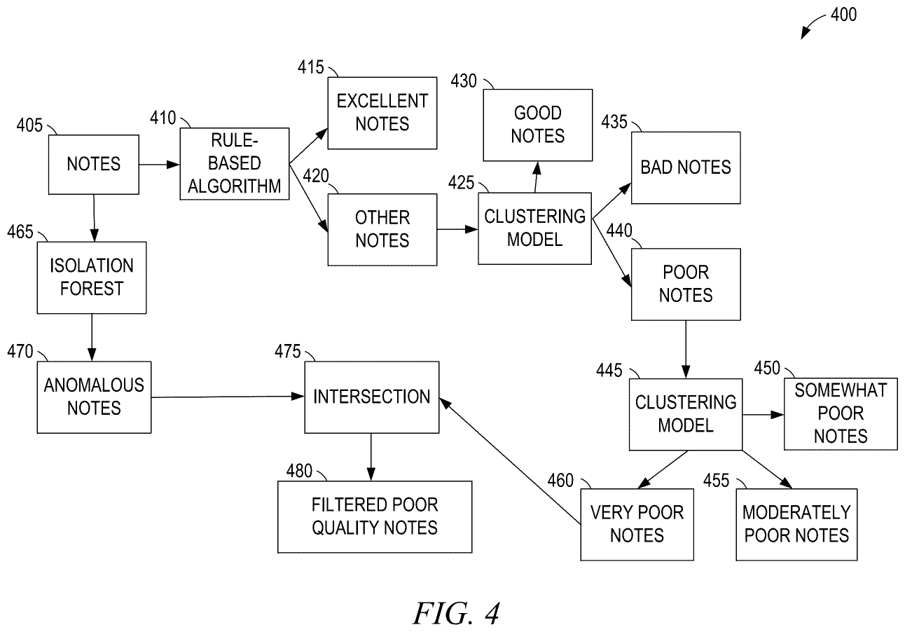

FIG. 4 is a block diagram of a model architecture 400 for automated assessment of note quality using clustering, according to some example embodiments. The model architecture 400 includes a rule-based algorithm 410, an isolation forest 465, a clustering model 425, a clustering model 445, and an intersection operator 475. These components operate on notes 405 and outputs from other components to categorize the notes 405 into clusters: excellent notes 415, good notes 430, bad notes 435, somewhat poor notes 450, moderately poor notes 455, very poor notes 460, and filtered poor quality notes 480.

Text of the notes 405 may be pre-processed before application of the rule-based algorithm 410. For example, the natural language toolkit (NLTK) for Python may be used to remove unnecessary symbols, HTML tags, extra spaces and the like. After pre-processing of the text, additional metrics may be calculated for use in processing the notes. Example metrics include a number of terms present in all of the text sections, a number of terms in an Other Terms section that do not appear in any other text section, a number of terms present in each section (e.g., the Solution section, the Other Terms section, and so on), overall length, or any suitable combination thereof.

The notes 405 are provided as input to the rule-based algorithm 410. The rule-based algorithm 410 applies rules to each note to identify excellent notes 415. For example, each note that is used to solve more than a predetermined number of support tickets, to include more than a predetermined number of keywords, to contain at least a predetermined number of terms in total, to contain at least a predetermined number of terms in a particular section, or any suitable combination thereof may be classified as an excellent note. For example, notes having an overall length that exceeds a first predetermined threshold may be categorized as excellent notes, notes having an overall length that exceeds a second (lower) predetermined threshold and a number of words in an Other Terms section that exceeds a third predetermined threshold may be categorized as excellent notes, or both. The non-excellent notes, other notes 420, are provided to the clustering model 425 for clustering.

Prior to clustering, the features may be scaled (e.g., using the StandardScaler library). The clustering model 425 clusters the other notes 420 into a predetermined number of clusters (e.g., using k-means clustering). In the example of FIG. 4, the number of clusters is three. The centroids of the clusters may be compared to determine which of the clusters comprises good notes 430, which comprises bad notes 435, and which comprises poor notes 440. For example, if the notes are represented by vectors comprising elements for which higher values are better (e.g., number of support tickets solved, user ratings, number of terms present in all sections, number of unique Other Terms present, and the like), the magnitude of the vector from the origin to the centroid may be used to rank the clusters as good, bad, and poor.

To further illustrate, consider an example in which five clusters are generated by the clustering model 425 operating on 11,479 notes. Example results are shown in the table below.

| Cluster | Volume (Number of Notes) | Percent Volume |
|---|---|---|
| 1 | 1839 | 16 |
| 2 | 1658 | 14.4 |
| 3 | 1388 | 12.1 |
| 4 | 143 | 1.25 |
| 5 | 6451 | 56.2 |

The notes (or the centroid) of each cluster is analyzed to determine mean characteristics, key features, and a note quality category, as shown below.

| | | | Note |
|---|---|---|---|
| | | | Quality |
| Cluster | Mean Characteristics | Key Features | Category |
| 1 | Second highest volume cluster with highest number | Average overall | Poor to |
| | of unique keywords, average overall length, low | length, highest | Medium |
| | length of Symptom, medium length of Title, low | number of | |
| | length of Reason & Prerequisites, lowest length of | unique keywords | |
| | Solution | | |
| 2 | Third highest volume cluster with medium number of | Medium overall | Poor to |
| | unique keywords, medium overall length, medium | length, medium | Medium |
| | length of Symptom, medium length of Title, low | number of | |
| | length of Reason & Prerequisites, medium length of | unique keywords | |
| | Solution | | |
| 3 | Second lowest volume cluster with low number of | High overall | Good |
| | unique keywords, second highest total length, second | length, low | |
| | highest length in Solution, second highest length in | number of | |
| | Symptom, medium length in Title, highest length in | unique keywords | |
| | Reason & Prerequisites | | |
| 4 | Lowest volume cluster with lowest number of unique | Highest overall | Good |
| | keywords, highest overall length, high length of | length, lowest | |
| | Symptom, low length of Title, high length in Reason | number of | |
| | & Prerequisites, medium length in Solution | unique | |
| | | keywords, | |
| | | lowest volume | |
| | | cluster | |
| 5 | Highest volume cluster with low number of unique | Lowest overall | Poor |
| | keywords, lowest overall length, lowest length in | length, low | |
| | Symptom, low length in Reason & Prequisites, | number of | |
| | lowest length in Title | unique keywords | |

The poor notes 440 are provided to the clustering model 445 for further clustering. The clustering model 445 clusters the poor notes 440 into a predetermined number of clusters (e.g., using k-means clustering). In this example, the number of clusters is, again, three. However, the number of clusters for the clustering model 445 may be greater or less than the number of clusters for the clustering model 425. The centroids of the clusters may be compared to determine which of the clusters comprises somewhat poor notes 450, which comprises moderately poor notes 455, and which comprises very poor notes 460.

To further illustrate, consider an example in which the clustering model 445 determines five sub-clusters from the poor quality cluster of 6,451 notes identified by the clustering model 425. The resulting sub-clusters are characterized in the table below by measuring the distance from the centroid of each sub-cluster to the centroid of each of the original five clusters.

| | Distance | Distance | Distance | Distance | Distance |
|---|---|---|---|---|---|
| | from | from | from | from | from |
| | Centroid of | Centroid of | Centroid of | Centroid of | Centroid of |
| | Original | Original | Original | Original | Original |
| Sub-Cluster | Cluster 1 | Cluster 2 | Cluster 3 | Cluster 4 | Cluster 5 |
| 1 | 2.55 | 2.21 | 1.55 | 9.36 | 1.92 |
| 2 | 3.05 | 2.98 | 2.32 | 9.49 | 2.59 |
| 3 | 4.59 | 4.49 | 3.13 | 6.02 | 4.19 |
| 4 | 0.81 | 1.86 | 3.05 | 10.44 | 1.48 |
| 5 | 2.60 | 2.31 | 3.01 | 10.51 | 0.75 |

Among all sub-clusters, the sub-cluster whose centroid is closest to the original poor quality cluster (original cluster 5) is sub-cluster 5. Accordingly, in this example, the notes in sub-cluster 5 are the very poor notes 460.

The notes 405 are also provided to the isolation forest 465 to identify anomalous notes 470. The isolation forest 465 quickly determines an anomaly score for each note. The notes with anomaly scores above a predetermined threshold, or a predetermined percentage of the notes 405 with the highest anomaly scores, are identified as anomalous notes 470.

An intersection operator 475 determines which notes are both in the set of anomalous notes 470 and the very poor notes 460. These notes are identified as filtered poor quality notes 480. The filtered poor quality notes 480 may be presented to a user for modification to improve their quality.

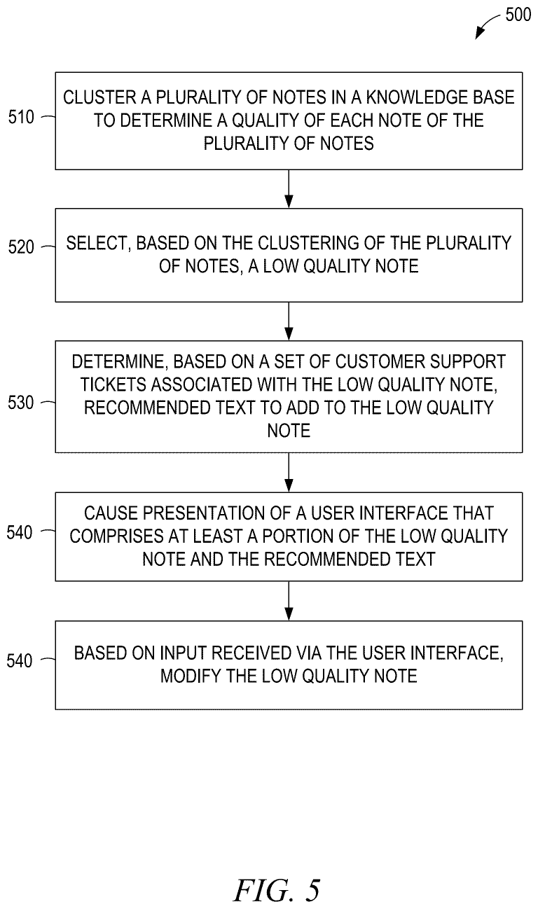

FIG. 5 is a flowchart illustrating operations of a method 500 suitable for automated assessment of note quality using clustering, according to some example embodiments. By way of example and not limitation, the method 500 is described as being performed by the assessment server 140 of FIG. 1, using the modules of FIG. 2 and the database schema 300 of FIG. 3.

In operation 510, the clustering module 230 clusters a plurality of notes in a knowledge base to determine a quality of each note of the plurality of notes. For example, notes in the note table 370 may be clustered to determine whether each note is in a high, medium, or low quality category.

The recommendation module 240 selects, based on the clustering of the plurality of notes, a low quality note (operation 520). Operation 520 may be repeated for all low quality notes. Alternatively, the note selected in operation 520 may be a lowest quality note, a low quality note that is also an anomalous note, or any suitable combination thereof.

In operation 530, the recommendation module 240 determines, based on a set of customer support tickets associated with the low quality note, recommended text to add to the low quality note. For example, the customer support tickets in the support ticket table 310 that were solved by the low quality note may be used as sources for the recommended text. Sentences in the customer support tickets may be ranked according to the number of keywords they contain, semantic similarity to the low quality note, semantic difference from the low quality note, or any suitable combination thereof.

In some example embodiments, the determining of the recommended text comprises selecting a sentence from among sentences in the set of customer support tickets. The selecting of the sentence may be based on a cosine similarity between the sentence and a title of the note. Alternatively, the selecting of the sentence may be based on a cat swarm optimization of the sentences in the set of customer support tickets.

The user interface module 250, in operation 540, causes presentation of a user interface that comprises at least a portion of the low quality note and the recommended text. The user may accept or edit the recommended text. Based on input received via the user interface (e.g., accepting or editing the recommended text), the assessment server 140 modifies the low quality note (operation 540).

Thus, by use of the method 500, low quality notes are automatically identified and modifications to improve their quality are automatically generated. A user is thereby enabled to quickly and easily modify low quality notes to improve the quality of a knowledge base.

In view of the above described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: one or more hardware processors; and a memory that stores instructions that, when executed by the one or more hardware processors, cause the one or more hardware processors to perform operations comprising: clustering a plurality of notes in a knowledge base to determine a quality of each note of the plurality of notes; selecting, based on the clustering of the plurality of notes, a low quality note; determining, based on a set of customer support tickets associated with the low quality note, recommended text to add to the low quality note; causing presentation of a user interface that comprises at least a portion of the low quality note and the recommended text; and based on input received via the user interface, modifying the low quality note.

In Example 2, the subject matter of Example 1, wherein the determining of the recommended text comprises selecting a sentence from among sentences in the set of customer support tickets.

In Example 3, the subject matter of Example 2, wherein the selecting of the sentence is based on a cosine similarity between the sentence and a title of the note.

In Example 4, the subject matter of Examples 2-3, wherein the selecting of the sentence is based on a cat swarm optimization of the sentences in the set of customer support tickets.

In Example 5, the subject matter of Examples 1-4, wherein the operations further comprise applying an isolation forest to a low quality cluster to identify a set of anomalous notes and the selecting of the low quality note comprises selecting the low quality note from the set of anomalous notes.

In Example 6, the subject matter of Examples 1-5, wherein the clustering of the plurality of notes comprises k-means clustering of the plurality of notes.

In Example 7, the subject matter of Examples 1-6, wherein the operations further comprise applying rules to identify excellent notes.

Example 8 is a non-transitory computer-readable medium that stores instructions that, when executed by one or more processors, cause the one or more processors to perform operations comprising: clustering a plurality of notes in a knowledge base to determine a quality of each note of the plurality of notes; selecting, based on the clustering of the plurality of notes, a low quality note; determining, based on a set of customer support tickets associated with the low quality note, recommended text to add to the low quality note; causing presentation of a user interface that comprises at least a portion of the low quality note and the recommended text; and based on input received via the user interface, modifying the low quality note.

In Example 9, the subject matter of Example 8, wherein the determining of the recommended text comprises selecting a sentence from among sentences in the set of customer support tickets.

In Example 10, the subject matter of Example 9, wherein the selecting of the sentence is based on a cosine similarity between the sentence and a title of the note.

In Example 11, the subject matter of Examples 9-10, wherein the selecting of the sentence is based on a cat swarm optimization of the sentences in the set of customer support tickets.

In Example 12, the subject matter of Examples 8-11, wherein the operations further comprise applying an isolation forest to a low quality cluster to identify a set of anomalous notes and the selecting of the low quality note comprises selecting the low quality note from the set of anomalous notes.

In Example 13, the subject matter of Examples 8-12, wherein the clustering of the plurality of notes comprises k-means clustering of the plurality of notes.

In Example 14, the subject matter of Examples 8-13, wherein the operations further comprise applying rules to identify excellent notes.

Example 15 is a method comprising: clustering, by one or more hardware processors, a plurality of notes in a knowledge base to determine a quality of each note of the plurality of notes; selecting, based on the clustering of the plurality of notes, a low quality note; determining, based on a set of customer support tickets associated with the low quality note, recommended text to add to the low quality note; causing presentation of a user interface that comprises at least a portion of the low quality note and the recommended text; and based on input received via the user interface, modifying the low quality note.

In Example 16, the subject matter of Example 15, wherein the determining of the recommended text comprises selecting a sentence from among sentences in the set of customer support tickets.

In Example 17, the subject matter of Example 16, wherein the selecting of the sentence is based on a cosine similarity between the sentence and a title of the note.

In Example 18, the subject matter of Examples 16-17, wherein the selecting of the sentence is based on a cat swarm optimization of the sentences in the set of customer support tickets.

In Example 19, the subject matter of Examples 15-18 includes applying an isolation forest to a low quality cluster to identify a set of anomalous notes and the selecting of the low quality note comprises selecting the low quality note from the set of anomalous notes.

In Example 20, the subject matter of Examples 15-19, wherein the clustering of the plurality of notes comprises k-means clustering of the plurality of notes.

Example 21 is an apparatus comprising means to implement of any of Examples 1-20.

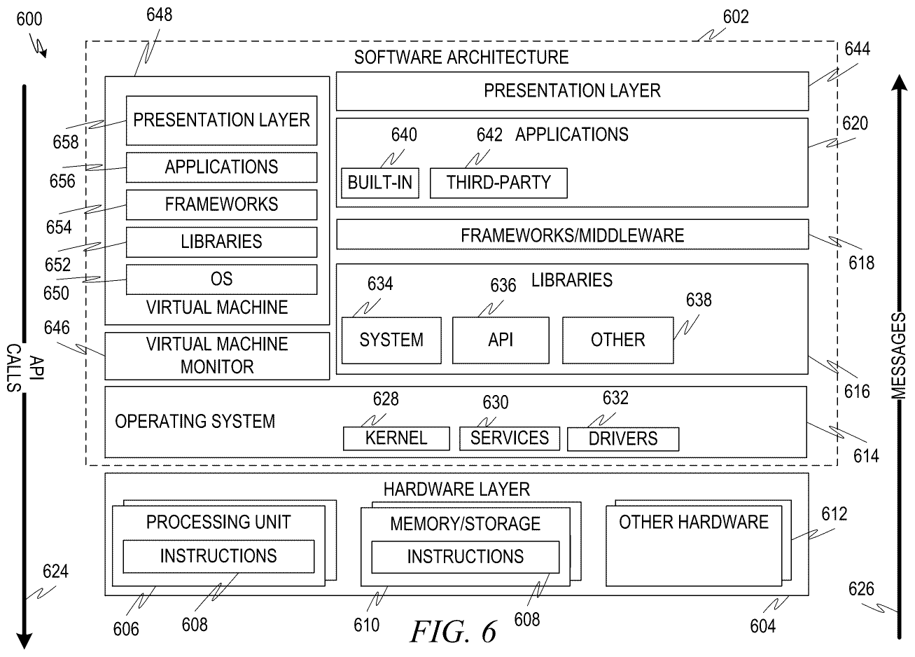

FIG. 6 is a block diagram 600 showing one example of a software architecture 602 for a computing device. The software architecture 602 may be used in conjunction with various hardware architectures, for example, as described herein. FIG. 6 is merely a non-limiting example of a software architecture and many other architectures may be implemented to facilitate the functionality described herein. A representative hardware layer 604 is illustrated and can represent, for example, any of the above referenced computing devices. In some examples, the hardware layer 604 may be implemented according to the architecture of the computer system of FIG. 6.

The representative hardware layer 604 comprises one or more processing units 606 having associated executable instructions 608. Executable instructions 608 represent the executable instructions of the software architecture 602, including implementation of the methods, modules, subsystems, and components, and so forth described herein and may also include memory and/or storage modules 610, which also have executable instructions 608. Hardware layer 604 may also comprise other hardware 612 which represents any other hardware of the hardware layer 604.

In the example architecture of FIG. 6, the software architecture 602 may be conceptualized as a stack of layers where each layer provides particular functionality. For example, the software architecture 602 may include layers such as an operating system 614, libraries 616, frameworks/middleware 618, applications 620, and presentation layer 644. Operationally, the applications 620 and/or other components within the layers may invoke application programming interface (API) calls 624 through the software stack and access a response, returned values, and so forth illustrated as messages 626 in response to the API calls 624. The layers illustrated are representative in nature and not all software architectures have all layers. For example, some mobile or special purpose operating systems may not provide the frameworks/middleware 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the software architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware 618 may provide a higher-level common infrastructure that may be utilized by the applications 620 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system such as operating system 614 to facilitate functionality described herein.

The applications 620 may utilize built in operating system functions (e.g., kernel 628, services 630 and/or drivers 632), libraries (e.g., system libraries 634, API libraries 636, and other libraries 638), frameworks/middleware 618 to create user interfaces to interact with users of the system. Alternatively, or additionally, in some systems, interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware computing device. A virtual machine is hosted by a host operating system (operating system 614) and typically, although not always, has a virtual machine monitor 646, which manages the operation of the virtual machine as well as the interface with the host operating system (i.e., operating system 614). A software architecture executes within the virtual machine 648 such as an operating system 650, libraries 652, frameworks/middleware 654, applications 656 and/or presentation layer 658. These layers of software architecture executing within the virtual machine 648 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube [CRT]). The computer system 700 also includes an alphanumeric input device 712 (e.g., a keyboard or a touch-sensitive display screen), a user interface (UI) navigation (or cursor control) device 714 (e.g., a mouse), a storage unit 716, a signal generation device 718 (e.g., a speaker), and a network interface device 720.

### Machine-Readable Medium

The storage unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable medium 722.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable medium 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 724 may further be transmitted or received over a communications network 726 using a transmission medium. The instructions 724 may be transmitted using the network interface device 720 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
one or more hardware processors; and
a memory that stores instructions that, when executed by the one or more hardware processors, cause the one or more hardware processors to perform operations comprising:
clustering a plurality of notes in a knowledge base to determine a quality of each note of the plurality of notes;
selecting, based on the clustering of the plurality of notes, a low quality note;
determining, based on a set of customer support tickets associated with the low quality note, recommended text to add to the low quality note;
causing presentation of a user interface that comprises at least a portion of the low quality note and the recommended text; and
based on input received via the user interface, modifying the low quality note.

2. The system of claim 1, wherein the determining of the recommended text comprises selecting a sentence from among sentences in the set of customer support tickets.

3. The system of claim 2, wherein the selecting of the sentence is based on a cosine similarity between the sentence and a title of the low quality note.

4. The system of claim 2, wherein the selecting of the sentence is based on a cat swarm optimization of the sentences in the set of customer support tickets.

5. The system of claim 1, wherein the operations further comprise applying an isolation forest to a low quality cluster to identify a set of anomalous notes and the selecting of the low quality note comprises selecting the low quality note from the set of anomalous notes.

6. The system of claim 1, wherein the clustering of the plurality of notes comprises k-means clustering of the plurality of notes.

7. The system of claim 1, wherein the operations further comprise applying rules to identify excellent notes.

8. A non-transitory computer-readable medium that stores instructions that, when executed by one or more processors, cause the one or more processors to perform operations comprising:
clustering a plurality of notes in a knowledge base to determine a quality of each note of the plurality of notes;
selecting, based on the clustering of the plurality of notes, a low quality note;
determining, based on a set of customer support tickets associated with the low quality note, recommended text to add to the low quality note;
causing presentation of a user interface that comprises at least a portion of the low quality note and the recommended text; and
based on input received via the user interface, modifying the low quality note.

9. The non-transitory computer-readable medium of claim 8, wherein the determining of the recommended text comprises selecting a sentence from among sentences in the set of customer support tickets.

10. The non-transitory computer-readable medium of claim 9, wherein the selecting of the sentence is based on a cosine similarity between the sentence and a title of the low quality note.

11. The non-transitory computer-readable medium of claim 9, wherein the selecting of the sentence is based on a cat swarm optimization of the sentences in the set of customer support tickets.

12. The non-transitory computer-readable medium of claim 8, wherein the operations further comprise applying an isolation forest to a low quality cluster to identify a set of anomalous notes and the selecting of the low quality note comprises selecting the low quality note from the set of anomalous notes.

13. The non-transitory computer-readable medium of claim 8, wherein the clustering of the plurality of notes comprises k-means clustering of the plurality of notes.

14. The non-transitory computer-readable medium of claim 8, wherein the operations further comprise applying rules to identify excellent notes.

15. A method comprising:
clustering, by one or more hardware processors, a plurality of notes in a knowledge base to determine a quality of each note of the plurality of notes;
selecting, based on the clustering of the plurality of notes, a low quality note;
determining, based on a set of customer support tickets associated with the low quality note, recommended text to add to the low quality note;
causing presentation of a user interface that comprises at least a portion of the low quality note and the recommended text; and
based on input received via the user interface, modifying the low quality note.

16. The method of claim 15, wherein the determining of the recommended text comprises selecting a sentence from among sentences in the set of customer support tickets.

17. The method of claim 16, wherein the selecting of the sentence is based on a cosine similarity between the sentence and a title of the low quality note.

18. The method of claim 16, wherein the selecting of the sentence is based on a cat swarm optimization of the sentences in the set of customer support tickets.

19. The method of claim 15, further comprising applying an isolation forest to a low quality cluster to identify a set of anomalous notes and the selecting of the low quality note comprises selecting the low quality note from the set of anomalous notes.

20. The method of claim 15, wherein the clustering of the plurality of notes comprises k-means clustering of the plurality of notes.
